(19) United States
(12) Patent Application Publication
(10) Pub. No.: US 2019/0119159 A1
(43) Pub. Date: Apr. 25, 2019

(54) COMPOSITE MATERIAL COMPRISING PHOSPHOGYPSUM

(71) Applicant: PHOSPHOGREEN LTD, Beer Sheva (IL)

(72) Inventors: Nathan DEJORNO, Beer Sheva (IL); Shlomi DEJORNO, Beer Sheva (IL)

(73) Assignee: PHOSPHOGREEN LTD, Beer Sheva (IL)

(21) Appl. No.: 16/093,284

(22) PCT Filed: Apr. 9, 2017
(86) PCT No.: PCT/IL2017/050435

§ 371 Date: Oct. 12, 2018

Related U.S. Application Data
(60) Provisional application No. 62/322,265, filed on Apr. 14, 2016.

(51) Int. Cl. C04B 18/04; C04B 28/14; C04B 26/26

(52) U.S. Cl. CPC C04B 18/0445; C04B 2111/26; C04B 26/26; C04B 28/143

(57) ABSTRACT

Provided is a composite material including a blend of components. The blend includes phosphogypsum, bitumen and particulate matter. The phosphogypsum may be present in an amount of at least 10% w/w out of the total weight of said composite material. Also provided herein is a method of producing the composite material, by, at least, mixing phosphogypsum and particulate matter at a temperature above 150° C. for a time sufficient to receive an essentially dry particulate mixture in which the amount of the phosphogypsum is such to obtain a composite material having at least 10% w/w out of the total dry weight of said composite material. While mixing molten bitumen may be introduced into the essentially dry particulate mixture to obtain the composite material. Articles of manufacture including the composite material are also disclosed.

### TECHNOLOGICAL FIELD

The present invention generally refers to processing of phosphogypsum waste.

### BACKGROUND ART

References considered to be relevant as background to the presently disclosed subject matter are listed below:
N. M. Katamine “Phosphate waste in mixtures to improve their deformation” J. Transp. Eng. 126:382-389 (2000);
A. A. Cuadri et al. “Valorization of phosphogypsum waste as asphaltic bitumen modifier” Journal of Hazardous Materials 279:11-16 (2014).

Acknowledgement of the above references herein is not to be inferred as meaning that these are in any way relevant to the patentability of the presently disclosed subject matter.

### BACKGROUND

Phosphogypsum refers to the gypsum formed as a by-product of the production of phosphoric acid from phosphate rock. In this process the phosphate ore, which is mainly composed of calcium phosphate (Ca₃(PO₄))₂ with sulfuric acid to produce phosphoric acid and gypsum (CaSO₄).

Phosphogypsum includes various hazardous impurities such as the radionuclides—uranium and thorium; heavy metals such as cadmium, chromium, copper, nickel, lead, mercury; and other hazardous species such as arsenic and fluoride.

The environmental impact of disposing large amounts of phosphogypsum poses major challenges, and thus, tons of phosphogypsum are stock-piled near phosphoric acid production plant. As such, the recycling of phosphogypsum waste is restricted to applications which are not negatively affected by the presence of impurities.

N. M. Katamine describes the deformation of mixtures comprising asphalt concerert and different phosphate fillers, among them phosphogypsum. It further describes that the mixtures comprising phosphogypsum exhibited poor behavior and thus recommends against using phosphogypsum as filler in wearing course mixtures.

A. A. Cuadri et al. describe the processing of asphaltic bitumen for use as paving material that comprises neat bitumen, 10% w/w phosphogypsum waste and 0.5% w/w sulfuric acid to obtain a material with altered properties. Typically, this type of process failed to result in recycling of significant amount of phosphogypsum waste, while comprising a large amount of bitumen.

### SUMMARY OF THE INVENTION

The present disclosure is aimed, inter alia, at providing a solution for phosphogypsum waste material. The solution is provided by processing phosphogypsum waste in combination with bituminous binder and particulate matter under conditions to obtain a compacted composite material that can be used in various applications, such as road blocks, as further discussed below.

Thus, the present disclosure provides, in accordance with its broadest aspect, a composite material comprising a blend of components comprising:

(a) phosphogypsum;

(b) bitumen;

(c) particulate matter (preferably, mineral aggregates);
the amount of said phosphogypsum is at least 10% w/w out of the total weight of said composite material.

Further provided by the present disclosure is a method of producing a composite material, the method comprising:

mixing phosphogypsum and particulate matter at a temperature above 150° C., said mixing is for a time sufficient to receive an essentially dry particulate mixture, the amount of phosphogypsum being such to obtain in the final composite material at least 10% w/w out of the total dry composite material;

introducing while mixing, into the essentially dry particulate mixture molten bitumen to obtain said composite material.

There is also provided by the present disclosure, a method of producing an article of manufacture, the method comprises:

mixing a blend of components as described above, and molding said blend into an article of manufacture

Yet further, the present disclosure also provides articles of manufacture comprising the composite material disclosed herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 provides the Ra²²⁶, Th²³², K⁴⁰ radionuclides content in a Composite Material according to an embodiment of the present invention and in a Reference Sample comprising concrete.

FIG. 2 is a graph of the ratio of the radionuclides content of Composite Material:Concrete Reference Sample of FIG. 1.

### DETAILED DESCRIPTION OF THE INVENTION

The present disclosure is aimed, inter alia, at providing a solution for phosphogypsum waste material. The solution is provided by processing phosphogypsum waste in combination with bituminous binder and particulate minerals to obtain a compacted composite material. The present disclosure thus provides a composite material made from the foregoing waste material, a method of processing the waste material into a composite material, a method of producing a composite material and articles of manufacture from the waste-derived composite material.

The present disclosure is based on the finding that mixing at least the components: (i) phosphogypsum (at least 10% w/w), (ii) particulate material and (iii) a bituminous binder (bituman), results in a composite material with improved chemical and physical characteristics as compared to those of phosphogypsum alone or of its combination with bituman.

In some embodiments, the composite material of the present disclosure has at least one of the following characteristics:
it is essentially dry (i.e. comprising only trace amounts of water, e.g. less than 5% w/w, at times, less than 4%, 2% or even 1% water out of the total weight of the composite material),
improved immobilization of hazardous impurities (such as, radionuclides, metals, inorganic anions),
stability and durability under various conditions (for example, corrosion stability, deformation resistance),
durability under various conditions (for example, adequate film thickness around the aggregate particles).

The composite material disclosed herein comprises a blend of the recited components, wherein the amount of said phosphogypsum is at least 10% w/w out of the total weight of said composite material.

In the context of the present disclosure, Phosphogypsum (“PG”) or phosphogypsum waste refers to the gypsum formed as a by-product of the production of phosphoric acid from phosphate rock. In this process the phosphate ore, which is mainly composed of calcium phosphate (Ca₃(PO₄)₂) with sulfuric acid to produce phosphoric acid and gypsum (CaSO₄—Calcium Sulfate), which is the main component of phosphogypsum. Typically, phosphogypsum also contains impurities resulting from the production process and the source of the ore, such as but not limited to, quartz, fluoride, phosphate, strontium, antimony, arsenic, lead, organic minerals; metals—such as aluminum, iron, silver, gold, cadmium, selenium, molybdenum, zinc and chromium; and radionuclides—such as uranium, radium and thorium.

In some embodiments, the composite material comprises at least about 10%, 15%, 20%, 25%, 30%, 35%, 40%, 45%, 50%, 55%, 60%, 65%, 70%, 75%, 80% or at least about 85% w/w phosphogypsum.

In some embodiments, the composite material comprises phosphogypsum in the range of between about 10% and about 85% w/w. In some embodiments, the composite material comprises phosphogypsum in an amount of not more than about 80% or even not more than about 70% out of the total composite material. The amount of phosphogypsum in the composite material, in some embodiments, is in the range of between about 10% w/w, 15%, 20%, 25%, 30%, 35%, 40%, 45% or 50% w/w as the lower limit in said range; and about 90%, 85%, 80%, 75%, 70%, 65%, 60%, 55%, 50% as the upper limit in said range. At times, the composite material of the invention comprises phosphogypsum in the range of between about 30% to about 80%.

At times, the composite material comprises phosphogypsum in the range of between about 40% and about 80% w/w, or between about 40% to 50% w/w.

It has been found that the combination of phosphogypsum, particulate minerals, and bitumen, produced by the process disclosed herein is unique in its specific gravity and/or Marshall stability and/or Marshall flow, as discussed below. Specifically, and without being bound by theory, it has been shown that the preliminary drying of phosphogypsum at elevated temperatures, e.g. above 150° C. allows for the dehydration of phosphogypsum, and thereby its high physical properties, notwithstanding its mixing with bitumen. This dehydration results in an essentially dry composite material (e.g. only trace amounts of water).

The results provided herein were surprising in view of the prior art teaching that in order to obtain improved rheological behavior there is a need to add sulfuric acid to the mixture of components upon preparation, to ensure the formation of C-O-P bonds with the bitumen, within the thus formed composite material (Cuadri et al. ibid.); or in view of the prior art teaching that the combination of phosphogypsum with bitumen led to inferior Marshall properties (collapsing of the thus formed mixture) as compared to other phosphorous fillers (this being probably due to the presence of water in the microcrystalline structure of the phosphogypsum) (Katamine. ibid.).

In the context of the present disclosure, it is to be understood that bitumen refers to a product resulting from the distillation of crude petroleum, by-products including asphalt (artificial or natural), pitch, tar and the like or mixtures.

Without being bound by theory, bituman is used herein as the binder. In some embodiments, the bitumen is selected to provide adhesion of the particulate minerals and phosphogypsum in the composite material.

In some embodiments, the composite material comprises at least about 1%, 2%, 4%, 6%, 8%, 10%, 12%, 13%, 14%, 15% or at least about 20% w/w bitumen out of the total weight of said composite material. In some embodiments, the composite material comprises at most about 20%, 18%, 16%, 15%, 14%, 13%, 12%, 11%, 10%, 9%, 8%, or at most about 6% w/w bitumen.

In some embodiments, the composite material comprises bitumen in the range of between about 2% w/w to about 50% w/w; at times, the composite material comprises bitumen in the range of between about 3% and about 20% w/w, typically, however not exceeding about 25%, 20% or even about 10% out of the total dry weight of the composite material.

The amount of bitumen in the composite material, in some embodiments, is in the range between any combination of about 2% w/w, 5%, 10%, 11%, 12%, 13%, 14% or 15% w/w as the lower limit in said range; and about 35%, 30%, 25%, 20%, 17% or 15% as the upper limit in said range.

Any combinations of the above upper and lower limits for bitumen form part of the invention.

At times, the composite material of the invention comprises bitumen in the range of between about 4% to about 20% w/w. At times, the composite material of the invention comprises bitumen in the range of between about 4% and about 14% w/w.

In some embodiments, the composite material comprises bitumen in the range of between about 8% to 14% w/w.

In some embodiments, the bitumen comprises asphalt.

Further, in the context of the present disclosure particulate matter refer to solid particles that can be naturally occurring or non-natural. In some embodiments, the particulate matter refers to inorganic particulate matter. In some embodiments, the particulate matter is selected from aggregates, sand, stone, gravel, slag and the like. Without being bound by theory, the particulate matter are selected to serve as a reinforcing element to add strength to the composite material.

The properties of the composite material may be adjusted to a desired end product by selecting the particulate minerals in accordance with their particle size, density, etc.

In some embodiments, the particulate minerals are selected from the group consisting of coarse aggregate, crushed rock, gravel and sand.

In some embodiments, the particulate minerals comprise aggregates.

In some embodiments, the particulate minerals comprise gravel.

In some embodiments, the particulate minerals have an average dimension of between about 0.01 mm to about 30 mm (for example, sand); at times between about 5 mm to about 20 mm.

In some embodiments, the composite material comprises between about 20% w/w to about 70% w/w particulate minerals out of the total weight of said composite material.

In some embodiments, the composite material comprises at least about 20%, 30%, 35%, 40%, 45%, 50% or at least about 55% w/w particulate minerals out of the total weight of said composite material. In some embodiments, the composite material comprises at most about 70%, 65%, 60%, 55%, 50%, 45%, 40%, 35% or at most about 30% w/w particulate minerals.

In some embodiments, the composite material comprises particulate minerals in the range of between about 30% to 50% w/w. Further, at times, the composite material of the invention comprises particulate minerals in the range of between about 35% to 50% w/w.

In some embodiments, the composite material comprises phosphogypsum in the range between about 25% and 50% w/w, particulate minerals in the range between about 25% and 50% w/w, and bitumen in the range between about 4% and 15% w/w.

In some embodiments, the composite material comprises phosphogypsum in the range between about 25% and 50% w/w, particulate minerals in the range between about 25% and 50% w/w, and bitumen in the range between about 8% and 15% w/w.

At times, the properties of the composite material may be fine-tuned by adding certain components to said material either during the preparation thereof or after it is formed. A non-limiting example is plastic/rubbery materials, including but not limited to thermosetting polymers, elastomers and thermoplastic polymers, which may improve the flexural properties and durability of the product, and thus resulting in improvement of fatigue cracking resistance. A further non-limiting example is fillers, glass fragments, ceramic materials, plasticizers, fibers (such as polymer and glass fibers), wood, metals, pigments and colorants. At times, salts (such as, sodium chloride, magnesium oxide, Dead-Sea minerals, etc) are added in order to increase the elasticity of the composite material.

Other non-limiting examples of such components are adhesion promoters which can improve the interfacial adhesion of the particles in certain conditions (for example, when the composite material is exposed to water), such as silanes and amines.

In some embodiments, the composite material is a homogeneous blend of the components, namely, the composite material has a substantial even distribution of the particles within the medium holding it, e.g. when viewed with a microscope, e.g., with an electronic microscope. The term “substantial even distribution” should be understood as referring to a compacted particle-containing medium where each particle has, in average, a same distance from its neighboring particles.

Phosphogypsum-containing materials typically comprise impurities including radionuclides—uranium, radium and thorium; metals such as cadmium, chromium, copper, nickel, lead, mercury; and other hazardous species such as arsenic and fluoride, and thus, phosphogypsum-containing materials are prohibited for use in various applications. Moreover, when phosphogypsum-containing materials are exposed to heat and/or water (especially salt water), chemical leaching of the abovementioned hazardous materials occurs.

Chemical leaking in accordance with the present invention denotes the emanating of chemical substances, including inorganic, organic contaminants or radionuclides from a composite material in certain conditions. Such conditions may include temperature, light, moisture, etc, which facilitate the emanating of said chemical substances.

Chemical leaching in accordance with the present invention refers to the extracting of chemical substances, including inorganic, organic contaminants or radionuclides from a composite material by dissolving said material in a liquid (i.e., water, aqueous solutions, rain—specifically acidic rain). These impurities are released from the solid phase of the composite material under the influence of dissolution, desorption or complexation processes when the composite material is exposed to a liquid. The leaching of impurities from the surface of the composite material or its interior depends, inter alia, on the porosity of the material.

In some embodiments, the composite material disclosed herein is characterized in accordance with the standard compliance test for detecting inorganic impurities of the European Council Decision 2003/33/EC.

In some embodiments, the leachates of the composite material disclosed herein are further analyzed according to ENV 12506.

It has been further unexpectedly found that the combination of the components, namely, particulate matter, phosphogypsum and bitumen as disclosed herein, produced a composite material that is tolerant to chemical leaking and/or chemical leaching.

When referring to tolerance, in the context of chemical leaking and/or chemical leaching it is to be understood that there is a low release (as determined by standard compliance tests) of hazardous materials in conditions such as heat, light and water as a result of the immobilization of these hazardous materials within the composite material.

When referring to resistance, in the context of chemical leaking and/or chemical leaching it is to be understood that there is no detectable release (as determined by standard compliance tests) of hazardous materials in conditions such as heat, light and water as a result of the immobilization of these hazardous materials within the composite material.

In view of the foregoing, one aim of the present disclosure was achieved by providing a composite material that minimizes the release of hazardous materials in such conditions (i.e., heat, light and water) by immobilization of these hazardous materials.

In this connection, and in some embodiments, the composite material disclosed herein is thus characterized by tolerance or resistance, manifested by one or more of the following properties:
less than 0.5 ppm As, preferably less than 0.1 ppm As;
less than 20 ppm Ba, preferably less than 1 ppm Ba;
less than 2 ppm Cu, preferably less than 1 ppm Cu;
less than 0.5 ppm Mo, preferably less than 0.3 ppm Mo;
less than 0.4 ppm Ni, preferably less than 0.2 ppm Ni;
less than 0.5 ppm Pb, preferably less than 0.3 ppm Pb;
less than 4 ppm Zn, preferably less than 2 ppm Zn;
less than 4,000 ppm total dissolved solids (TDS), preferably less than 1,000 ppm TDS.

The above characteristics was determined in a chemical leaching test when the composite material is immersed in a liquid at suitable conditions to allow extraction of the above inorganic impurities, and analyzing the amount of inorganic impurities in said liquid. In accordance with some embodiments, said liquid is water and said suitable conditions are at a temperature of 60° C. for 21 days.

Generally, the total dissolved solids (TDS) is a measure of the combined content of all inorganic and organic substances contained in a liquid in molecular, ionized or micro-granular (colloidal sol) suspended form, and is a measure of the corrosion resistance of the composite material when it is exposed to a liquid, specifically, aqueous solutions. An inert waste is typically characterized by TDS of less than 4,000 ppm.

In accordance with some embodiments, the composite material has less than 4,000 ppm total dissolved solids (TDS), at times less than 2,000 ppm, at times less than 1,000 ppm preferably less than 5.00 ppm TDS.

In accordance with some embodiments, the composite material is corrosion resistant. This is evident from the pH of a medium obtained in the chemical leaching test as described above, the pH being in 4.8-5.4. Thus, in the context of the present disclosure when referring to a composite material that is corrosion resistant, it is understood that in a chemical leaching test the pH of the medium is in the range of between 4.5 to 5.5, at times between 4.7 to 5.5.

In accordance with some embodiments, the composite material is characterized by being tolerant or resistant to chemical leaking. This is determined by the absence of leaked radionuclides as determined by the Standards Institute of Israel test 5098.

In some embodiments the radionuclides or radioactive elements content of the composite material disclosed herein can be determined as per the Standards Institute of Israel test 5098. Specifically the content of each sample separately can be determined by the following procedure:

The composite material samples are crushed in a manner such that the samples material completely passes through a sieve of mesh size 1.18 mm, and then the material that passed through the sieve is dried at a temperature of 105±5° C. until a constant weight is obtained. The crushed material is stirred and placed it in a container of a known weight, suitable for the measuring detector type.

Next the container is filled and compacted, the excess material is removed and measurements of the and weigh are taken. The contained is closed, sealed, and maintain sealed for at least three weeks until the secular equilibrium of ²²⁶Ra and radon progeny is obtained.

The activity of the radioactive elements ²²⁶Ra, ²³²Th and ⁴⁰K can be measured by means of a calibrated gamma spectrometer placed in an approved laboratory. The system detector is placed in a protected and closed. The energy calibration of the detector includes the complete energy spectrum required in order to quantitatively determine the concentration of radioisotopes ²²⁶Ra, ²³²Th and ⁴⁰K.

The measurement detection limit of the radioisotopes, ²²⁶Ra and ²³²Th shall not exceed 2 Bq/kg, while the limit of detection for ⁴⁰K shall not exceed 20 Bq/kg.

The contents can be calculated as the mean activity concentration of the test specimen. The calculation shall be determined by dividing the measured activity of the element by the specimen mass as measured, in units of Bq/kg of dry material.

In this context, when referring to tolerance or resistance to leakage, it is to be understood as having a leakage level that is statistically significant below the leakage of the same entity from phosphogypsum alone.

According to the Standards Institute of Israel test 5098, the standard leakage for Ra²²⁶ and Th²³² radionuclides detected in the composite material disclosed herein is substantially lower than the standard content detected in phosphogypsum waste alone.

In accordance with some embodiments, the composite material is resistant to chemical leaking of the radionuclides of any one of Ra, Th, K, U and Pb, namely, having a concentration of any one of said radionuclides below a standard threshold with respect to phosphogypsum alone.

In some embodiments, the composite material has Ra²²⁶ content below 400 Bq/kg, at times, below 350 Bq/kg, 320 Bq/kg, and even below 310 Bq/kg.

In some embodiments, the composite material has Th²³² content below 6 Bq/kg, at times, below 5 Bq/kg, 4 Bq/kg, and even below 3 Bq/kg.

In some embodiments, the composite material has K⁴⁰ content below 20 Bq/kg, at times, below 18 Bq/kg, 17 Bq/kg, and even below 15 Bq/kg.

In some embodiments, the composite material disclosed herein is characterized by its Marshall stability determined as per the Standards Institute of Israel test No. 1865-2, being no more than 16,000 Lb, at times, no more than 14,500 Lb, 13,500 Lb, and even no more than 12,000 Lb.

In some embodiments, the composite material disclosed herein is characterized by its Marshall flow determined as per the Standards Institute of Israel test No. 1865-2, being at least 22 increments of 0.01 inch, at times, at least 25, 26, 27, 28, 29, 30, 31, and even at least 32.

In some embodiments, the composite material disclosed herein is characterized a specific gravity or the of at least 2000 determined as per the Standards Institute of Israel test No. 1865-2 (ASTM C 127 or ASTM C 128).

In some embodiments, the specific gravity is determined by oven drying the composite material to constant mass of 110° C.±5° C., allowing the composite material to cool in room temperature for 1-3 hours and weight (‘A’). Measuring the mass of specimen in water (‘C’) by immersing the specimen in water bath at room temperature for 24±4 hours, and weight (under water). Measuring the mass of Saturated Surface Dry Specimen (‘B’) by soaking up the composite material with an absorbing towel until all visible water are removed from the surface and then weight in air. The density is calculated based on the following formula:

$$\frac{A}{B - C}$$

To determine the specific gravity, the density is then typically divided by that of water.

Marshall Stability is the peak resistance load obtained during a constant rate of deformation loading sequence. Marshall Stability can also be defined as the load obtained, when the rate of loading increase begins to decrease, such that the curve starts to become horizontal.

Marshall Flow is a measure of deformation (elastic plus plastic) of the bituminous mix determined during the stability test. Marshall Flow is the total sample deformation from the point where the projected tangent of the linear part of the curve intersects the x-axis (deformation) to the point where the curve starts to become horizontal. The flow value is recorded in 0.01 inch (0.25 mm) increments at the same time the maximum load is recorded.

The principle of the test is that Marshall Stability is the resistance to plastic flow of a bituminous sample loaded on the lateral surface at a temperature of 140° C. at a specific loading rate (see in this connection also the Non-Limiting Examples). The test load is increased until it reaches a maximum. During the loading test, a dial gauge is attached to the measuring apparatus, which measures the sample's plastic flow as a result of the applied load. This flow value refers to the vertical deformation when the maximum load is reached.

In some embodiments, the Marshal stability and Marshal flow can be determined according to the procedure described in the Non-Limiting Examples, forming part of the present disclosure.

The composite material disclosed herein is obtainable through processing together phosphogypsum waste (or phosphogypsum), particulate minerals and bitumen binder.

In some embodiments, the processing method comprises:

mixing a combination of components to form a blend comprising bitumen, phosphogypsum and particulated minerals under conditions where said bitumen is heated to be in molten form and allowing said blend to cool.

In some embodiments, the conditions comprise heating the bitumen to a temperature of at least 100° C.

In some embodiments, the conditions comprise heating the bitumen before the mixing with phosphogypsum.

In yet some other embodiments, the conditions comprise heating the bitumen during its mixing with at least the phosphogypsum.

The composite material can be further processed or used as a starting material in the production of articles. Accordingly, in some embodiments, there is disclosed herein a method of producing an article of manufacture, the method comprises:

mixing a blend of components comprising bitumen, phosphogypsum and particulated minerals under conditions where said blend is in molten form; and

molding said blend into an article of manufacture.

In some embodiments, the molding comprises applying pressure onto the molten form of the blend of components to obtain a compacted material.

In some embodiments, the applying pressure comprises one or more vertical blows onto a hydraulic or compaction mold holding the blend. At times, the compacted material is obtained by compacting as aforesaid while simultaneously being periodically vibrated.

In some embodiments, the pressure comprises a load pressure of at least 100 kg.

In some embodiments, the pressure comprises applying at least 10, at times, at least 20, at least 30, at least 40, at least 50, at least 60, and even at least 70 vertical blows onto the mold.

There are a variety of articles that can be produced from the composite material disclosed herein. Without being limited thereto, the composite material can be processed into pavement products, playground pallets, roads, traffic separators, traffic barriers, concrete replacement, pavers, sewage and wastewater pipes, retaining walls, etc.

### DETAILED DESCRIPTION OF NON-LIMITING EXAMPLES

### Example 1

### Processing Equipment

In the following processes various devices and systems were employed, including conventional oven, mixing apparatus, compaction mold apparatus, etc.

### Preparation of a Gravel:Phosphogypsum:Bitumen Composite

Phosphogypsum waste was obtained from a phosphoric acid production plant in Israel. Sieved gravel aggregates were heated in an oven at 180° C. Then, the hot sieved aggregates were mixed with the phosphogypsum waste at a weight ratio of 1:1 (aggregates:phosphogypsum) to obtain a mixture. Alternatively, the sieved gravel aggregates and the phoshpogypsum were heated together at said temperature of 180° C. Molten bitumen, at different % w/w (between 12% to 15% w/w bitumen out of the total weight of the heated (and dried) gravel:phosphogypsum mixture) was added to the hot mixture and mixed therewith thoroughly to provide a substantially homogeneous blends (Samples 1 to 4) of the three components.

For the Marshall test, each of the cooled composite materials (blends) were introduced into a compaction mold arranged on a compaction pedestal and heated to 140° C. Then, the samples were subjected to 50 or 75 compaction blows during periodic vibration from its top side using a standard compaction 300 kg/cm hammer at 140° C. to provide compacted samples. The compacted samples were then cooled to room temperature and removed from the mold apparatus.

### Marshall Test

The Marshall test were performed by the in the Asphalt Laboratory of the Standards Institution of Israel. As shown in Table 1 varying amount of bitumen was used in each sample.

Marshall Stability and Marshall Flow are bituminous mixture characteristics determined from tests of compacted specimens of a specified geometry. Marshall Stability and Marshall Flow of the samples produced as described above were determined as per the Standards Institute of Israel test No. 1865-2 (based on ASTM D 362).

Specifically, each of the molded samples was soaked in hot water at 60° C. for 30-40 minutes, and the stability of the molded samples on the Marshall Stability (in kg) as a function of % bitumen in each sample was measured.

### Specific Gravity of Compacted Samples

Specific gravity of the samples was measured by the Standards Institute of Israel test No. 1865-2.

The characteristics of each compacted sample are presented in Table 1.

TABLE 1
Marshall properties of compacted samples

| | % w/w | Average | Average | Average |
|---|---|---|---|---|
| Sample No. | bitumen | specific gravity | Stability [Lb.] | Flow[0.01″] |
| 1 | 12 | 2004 | 14270 | 32 |
| 2 | 13 | 2029 | 11760 | 25 |
| 3 | 14 | 2050 | 13500 | 26 |
| 4 | 15 | 2070 | 16520 | 28 |
| 5 | 10 | 1913 | 2115 | 21 |
| (Reference | | | | |
| Sample, | | | | |
| no PG) | | | | |

Table 1 compares the Marshall properties of Samples 1-4 with a Reference Sample without phosphogypsum (Sample No. 5 in Table 1), which contained 10% w/w bitumen out of the total weight of the heated (and dried) gravel:sand mixture.

The results show that the combination of phosphogypsum with bitumen and gravel substantially improved the properties of the Samples, including, increased specific gravity, average stability and average flow. These results indicate a material that has improved sealing, and thus, less prone to radionuclides leaking and/or chemical leaching from the material.

### Example 2: Further Samples and Characteristics

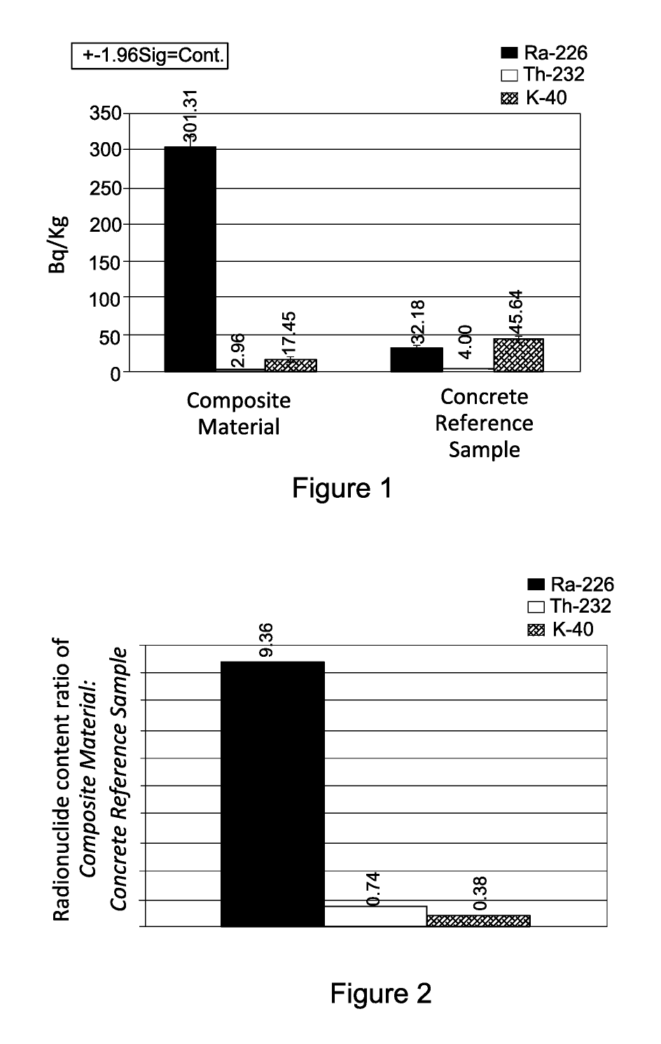

Further samples were prepared as described in Example 1, however, some containing a different phosphogypsum:aggregates composition as described in Table 2. The various samples were then analyzed for chemical impurities leaching (Table 3) and radionuclides leaking (FIG. 1) properties.

TABLE 2
Samples composition

| | | | Bitumen content |
|---|---|---|---|
| | Phosphogypsum | Gravel | (% w/w out of the |
| | (PG) content | content | total weight of the |
| Sample No. | [% w/w] | [% w/w] | PG:gravel mixture) |
| 5 | 50 | 50 | 15 |
| 6 | 40 | 60 | 15 |
| 7 | 70 | 30 | 10 |
| 8 | 60 | 40 | 13 |

### Leaking Tests

### A. Radionuclides

Radionuclides content in Sample 2 of Table 1 (according to the present disclosure) and in a Concrete Reference Sample, the latter comprising concrete mix B-400 (prepared from a mixture of sand:gravel:cement:water in weight ratio 900:900:300:200), were determined in accordance with the standard compliance test for detecting natural radionuclides by the Standards Institute of Israel test 5098, specifically, leakage of Ra²²⁶, Th²³² and K⁴⁰.

FIG. 1 shows that the content of Ra²²⁶ and Th²³² radionuclides detected in Sample 2 (referred to in FIG. 1 as “Composite Material”) was substantially lower than the standard content detected in phosphogypsum waste alone, which is known to be 590 Bq/kg and 8.2 Bq/kg, for Ra²²⁶ and Th²³², respectively. The positive effect in preventing leakage may be due to the structure and/or interaction between the components, which may result in improved immobilization of these radioactive elements.

FIG. 2 displays the ratio of radionuclides in Composite Material:Concrete Reference Sample. The results suggest that the combination of phosphogypsum with bitumen and gravel reduces radionuclide's leakage, with a most significant reduction of at least Th²³² and K⁴⁰. In addition, the ratio of Ra²²⁶ detected of 9.36 in the Composite Material:Concrete Reference Sample is lower than the threshold for transporting materials in accordance with the Standards Institute of Israel No. 5098.

Leaching of inorganic impurities from Samples 5-8 according to the present disclosure (Table 2) was also evaluated. The tests were conducted in accordance with the standard compliance test for detecting inorganic impurities of the European Council Decision 2003/33/EC.

The analysis was focused on detection of inorganic impurities in the Samples 5-8 including As, Ba, Cd, Cr, Cu, F, Hg, Mo, Ni, Pb, Sb, Se, SO₄ and Zn and the results are presented in Table 3.

Specifically, in Table 3, only ions that were found to be present in Samples 5-8 above the standard detection limit were: fluoride (F) in a concentration of 73-118 ppm, SO₄ in a concentration of 2931-5512 ppm, and Mo in a concentration of 1.47 ppm.

TABLE 3
Leaching analysis of inorganic impurities
of Samples 5-8 of the invention

| | | Threshold | | | | |
|---|---|---|---|---|---|---|
| | | values for | | | | |
| | | impurities | | | | |
| Element | Inert | in residen- | Sam- | Sam- | Sam- | Sam- |
| [ppm] | waste | tial land | ple 5 | ple 6 | ple 7 | ple 8 |
| As | 0.5 | 17 | 0 | 0 | 0 | 0 |
| Ba | 20 | | 0.36 | 0.07 | 0.12 | 0.17 |
| Cd | 0.04 | 10 | 0 | 0 | 0 | 0 |
| Cr | 0.5 | 150 | 0 | 0 | 0 | 0 |
| Cu | 2 | 150 | 0.2 | 0.2 | 0.3 | 0.4 |
| F | 10 | | 81 | 73 | 95 | 118 |
| Hg | 0.01 | 5 | | | | |
| Mo | 0.5 | | 0.256 | 0 | 1.47 | 0 |
| Ni | 0.4 | 130 | 0 | 0 | 0 | 0 |
| Pb | 0.5 | 250 | | 0 | 0 | 0 |
| SO₄ | 1000 | 1500 | 4992 | 2931 | 5512 | 4829 |
| Zn | 4 | | | 1.5 | 2 | 2.1 |
| TDS | 4000 | | 450 | 300 | 450 | 600 |
| pH | | | 4.8 | 5.4 | 5.4 | 4.9 |

1.-24. (canceled)

25. A composite material comprising a blend of components comprising:
(a) phosphogypsum;
(b) bitumen;
(c) particulate matter;
the amount of said phosphogypsum is at least 20% w/w out of the total weight of said composite material.

26. The composite material of claim 25, being essentially water free.

27. The composition material of claim 25, comprising at least 25% w/w phosphogypsum out of the total dry weight of said composite material.

28. The composite material of claim 25, comprising between 1% to 15% w/w bitumen out of the total dry weight of said composite material.

29. The composite material of claim 25, being tolerant or resistant to chemical leaking and/or chemical leaching of any one of Ra, Th, K, U and Pb.

30. The composite material of claim 25, characterized by having one or more of the following characteristics:
less than 0.5 ppm As;
less than 20 ppm Ba;
less than 2 ppm Cu;
less than 0.5 ppm Mo;
less than 0.4 ppm Ni;
less than 0.5 ppm Pb;
less than 4 ppm Zn; and
less than 4,000 ppm total dissolved solids (TDS).

31. The composite material of claim 25, wherein said particulate matter has an average dimension of between 0.01 mm to 30 mm and comprises minerals.

32. The composite material of claim 25, wherein said particulate matter is selected from the group consisting of coarse aggregate, crushed rock, gravel and sand and any combination of same.

33. The composite material claim 25, comprising between 20% w/w to 70% w/w particulate matter out of the dry total weight of said composite material.

34. The composite material of claim 25, wherein said composite material is a homogenous blend of its components.

35. An article of manufacture comprising a composite material of claim 25.

36. A method of producing a composite material, the method comprising:
mixing phosphogypsum and particulate matter at a temperature above 150° C., said mixing is for a time sufficient to receive an essentially dry particulate mixture, the amount of said phosphogypsum is such to obtain a composite material having at least 20% w/w out of the total dry weight of said composite material;
introducing while mixing, into the essentially dry particulate mixture molten bitumen to obtain said composite material.

37. The method of claim 36, wherein said molten bitumen is obtained by heating said bitumen to a temperature of at least 100° C.

38. The method of claim 36, wherein said mixing of phosphogypsum and particulate matter is at a weight % ratio of between 70:30 to 30:70.

39. The method of claim 38, wherein said mixing of phosphogypsum and particulate matter is at a weight ratio of about 1:1.

40. The method of claim 36, comprising introducing bitumen in an amount of between 1% to 15% out of the total weight of said phosphogypsum and particulate matter.

41. The method of claim 36, wherein said molten bitumen is sprayed over the essentially dry mixture of phosphogypsum and particulate matter.

42. A method of producing an article of manufacture, the method comprises molding a composite material according to claim 25.

43. A method of producing an article of manufacture, the method comprises molding a composite material produced by the method of claim 36.
